(19) United States
(12) Patent Application Publication
(10) Pub. No.: US 2006/0169863 A1
(43) Pub. Date: Aug. 3, 2006

(54) Seat position adjusting device of automotive vehicle

(75) Inventors: Tomonori Ohtsubo, Hiroshima (JP); Hiroki Uemura, Hiroshima (JP); Naoki Yamada, Hiroshima (JP); Yasuhiko Miura, Hiroshima (JP)

Correspondence Address: NIXON PEABODY, LLP, 401 9TH STREET, NW, SUITE 900, WASHINGTON, DC, 20004-2128, US

(73) Assignee: MAZDA MOTOR CORPORATION, Hiroshima (JP)

(21) Appl. No.: 11/336,845

(22) Filed: Jan. 23, 2006

(30) Foreign Application Priority Data
Jan. 28, 2005 (JP) 2005-020636
Feb. 8, 2005 (JP) 2005-031368

(51) Int. Cl. F16M 13/00

(52) U.S. Cl. 248/429

(57) ABSTRACT

The seat face's position is adjusted by the position adjusting device in such a manner that the passenger's hip point Hpt lowers as the seat cushion is moved rearward, and the degree of the hip point lowering is configured such that the lowering degree of the hip point Hpt at the central section B is greater than that of the hip point lowering at the rear section C and the front section A that are located behind and before the central section C respectively. Accordingly, the proper sitting position to any passengers with different body sizes can be provided.

### BACKGROUND OF THE INVENTION

The present invention relates to a seat position adjusting device of an automotive vehicle that can provide a proper sitting position to a passenger regardless of a different body size of the passenger.

A seat position adjusting device comprising a slide mechanism to move a seat cushion longitudinally and a lift mechanism to move the seat cushion vertically is known.

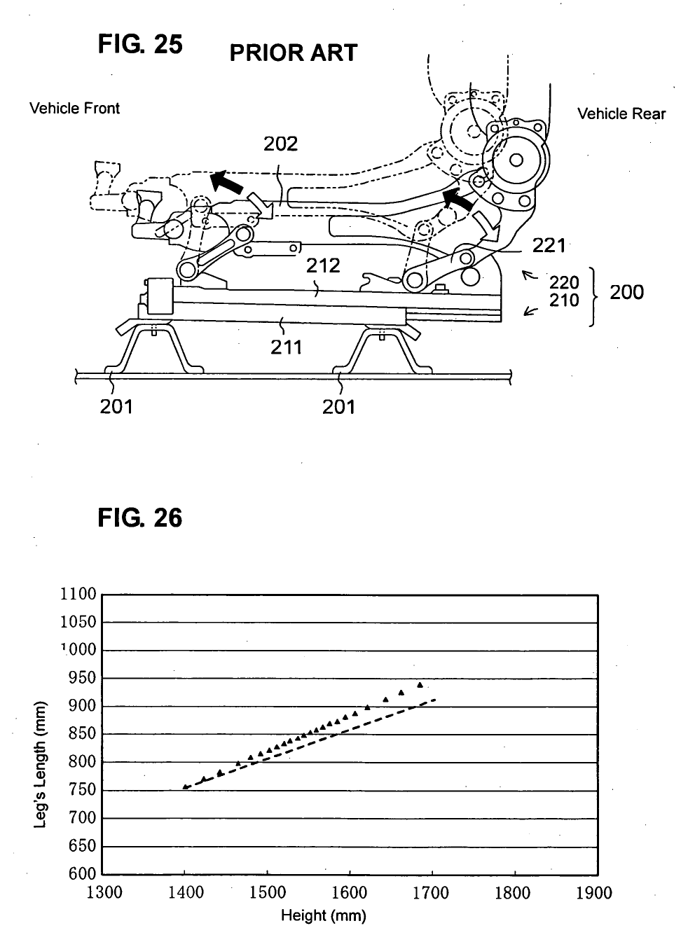

This seat position adjusting device includes, as illustrated in FIG. 25, a slide mechanism 210 that is disposed on two laterally-extending cross members 201, 201 disposed longitudinally, and a lift mechanism 220 that comprises a link member 221 provided on an upper rail 212 of the slide mechanism 210. Specifically, the slide mechanism 210 is comprised of a pair of longitudinally-extending lower rails 211 located on the cross members 201, 201 and a pair of upper rails 212 to slide longitudinally on the lower rails 211. The upper rails 212 are allowed to slide longitudinally on the lower rails 211 with an operation of a first operating lever, not illustrated, that is provided at the upper rails 212.

The lift mechanism 220 comprises the link member 221 connecting the upper rails 212 with a lower arm 202 of a seat cushion, not illustrated, and one end of the link member 221 is pivotally connected to the upper rail 212 so that it can rotate longitudinally. Further, a second operating lever, not illustrated, is provided at the link member 221, and an operation of this second operating lever allows the link member 221 to rotate around the pivotal point, so that the seat cushion can be moved forward and upward, or rearward and downward.

The above-described seat position adjusting device adjusts the longitudinal position and the vertical position of the seat cushion with separate respective operations. Further, another type of device, in which the vertical position of the seat cushion can be also adjusted with the adjustment operation of the longitudinal position thereof, is known, for example, as shown in Japanese Patent Laid-Open Publication No. 62-116324.

In the device disclosed in this publication, the upper and lower rails are provided in such a manner that their front portions are higher than their rear portions relative to a floor surface, so the seat's position is changed vertically as the upper rails slide on the lower rails. Further, there is provided a pin projecting from a side of the seat, and the pin is guided in a arc-shaped groove as the seat is moved longitudinally. Thereby, the seat face's vertical position can be changed nonlinearly relative to the seat longitudinal movement according to a shape of the groove, namely, in such a manner that the seat face's vertical position changing degree relative to the seat longitudinal movement at the front section is smaller than that relative to the seat longitudinal movement at the rear section.

Herein, the proper sitting position of the passenger may require some conditions, such as that the height of the passenger's eyes could be appropriate so as to provide the passenger with a clear and proper front view beyond an engine hood of the vehicle, a brake pedal and other pedals could be operated properly, the passenger could feel comfortable. In general, relationships between the height of the passenger and the length of the passenger's legs can be shown as FIG. 26, namely, the taller the passenger is, the longer legs the passenger has. Accordingly, in order to provide any passengers with proper sitting positions, a seat face of the seat needs to be adjusted in accordance with the passenger's body size.

Namely, since a taller passenger has longer legs and higher sitting height, the seat needs to be located rearward and its seat face needs to be lowered. By contrast, for a shorter passenger, it would be preferable that the seat is located relatively forward and its sitting seat face is relatively higher. Meanwhile, there is a tendency, as shown in FIG. 26, that the taller passenger has great ratio of the leg's length relative to the height compared with the shorter passenger (its ratio of the shorter passenger is shown in a broken line in FIG. 26). Accordingly, there are problems that a too-low positioning of the seat face would cause an inappropriately-low eyes height of the passenger and an inappropriately-narrow bending angle at the passenger's knee, thereby providing uncomfortable positioning to the passenger. Meanwhile, a too-high positioning of the seat face would cause an inappropriate operation for the shorter passenger. For these reasons, it will be necessary that the seat face of the seat could be adjusted at an appropriate position, not being moved upward or downward so much, for both the tall passenger and the short passenger.

Herein, in the case where this seat positioning adjustment is attained by the above-described conventional device, two separate operating levers would be necessary and the adjustments would not be so easy and thereby the passenger would not complete the adjustments preferably promptly.

Further, in the conventional device in which the seat height changes in accordance with the forward movement of the seat, the longitudinal position and the vertical position of the seat could be adjusted properly by an one-direction operation (longitudinal operation) for the seat located on the front side. However, when the seat is located on the rear side, the seat face would be lowered in proportion to the rearward movement, so the proper sitting position could not be provided to the relatively tall passenger.

### SUMMARY OF THE INVENTION

The present invention has been devised in view of the above-described problems, and an object of the present invention is to provide the seat position adjusting device of an automotive vehicle that can provide a proper sitting position to any passengers with different body sizes.

According to the present invention, there is provided a seat position adjusting device of an automotive vehicle, comprising a seat operative to be movable in a vehicle longitudinal direction, and a position adjusting device operative to adjust a position of a seat face of a seat cushion of the seat, wherein the position adjusting device adjusts the seat face's position in such a manner that a hip point of a passenger seated in the seat lowers as the seat is moved rearward at least in a specified area where the seat is movable, and a degree of the hip point lowering is configured such that the lowering degree of the hip point at a central section in the specified area is greater than that of the hip point lowering at a rear section and a front section that are located behind and before the central section respectively.

Accordingly, when the seat cushion is located at the central section in the seat's movable area, the seat face's position is adjusted such that the passenger's hip point lowers as the seat is moved rearward. When the seat cushion is located at the rear section in the seat's movable area, namely in the case where a relatively tall passenger-is seated in the seat, the seat face's position is adjusted such that the lowering degree of the hip point is relatively small compared with the hip point lowering at the central section. Thereby, the seat position can be adjusted properly, so the proper height of eyes can be maintained even when the relatively tall passenger is seated.

When the seat cushion is located at the front section in the seat's movable area, namely in the case where a relatively short passenger is seated in the seat, the seat face's position is adjusted such that the lowering degree of the hip point is relatively small compared with the hip point lowering at the central section. In other words, the position adjusting device adjusts the seat face's position in such a manner that the hip point rises as the seat is moved forward, and the seat face's position is adjusted such that the rising degree of the hip point at the front section is relatively small compared with the hip point rising at the central section. Thereby, the operation of pedals can be prevented from deteriorating due to a too-high hip point even when the relatively short passenger is seated. Accordingly, the proper sitting position can be provided regardless of the body size of the passenger.

According to an embodiment of the present invention, the position adjusting device adjusts the seat face's position in such a manner that a vertical position of the hip point of the passenger is kept substantially at a constant level at the rear section in the specified area. Accordingly, even when the relatively tall passenger is seated, the lowering movement of the position adjusting device can be made small, so a space for the lowering movement of the seat cushion can be saved properly.

According to another embodiment of the present invention, the vehicle comprises an another seat located behind the seat, there is further provided a rearmost area that is located behind the rear section in the specified area, the position adjusting device adjusts the seat face's position in such a manner that the hip point of the passenger seated in the seat rises as the seat is moved rearward at the rearmost area. Accordingly, a foot space for a passenger seated in this rear seat can be enlarged, so the passenger in this seat can feel comfortable.

According to another embodiment of the present invention, the position adjusting device adjusts the seat face's position in such a manner that a vertical position of the hip point of the passenger is kept substantially at a constant level at the front section in the specified area. Accordingly, even when the relatively short passenger is seated, the rising movement of the position adjusting device can be made small, so a space in a vehicle cabin can be used effectively. Also, a gap between the passenger seated and a vehicle roof is not made too narrow, which may not provide the passenger with a sense of oppression.

According to another embodiment of the present invention, the position adjusting device adjusts the seat face's position in such a manner that the hip point of the passenger seated in the seat lowers as the seat is moved forward at the front section in the specified area. Accordingly, even when the seat cushion is located at the front section, the enough gap between the passenger seated and the vehicle roof can be obtained, so the sense of oppression the passenger feels can be effectively reduced.

According to another embodiment of the present invention, the position adjusting device comprises a tilt mechanism to adjust the seat face's position in such a manner that the seat face's position tilts forward as the seat is moved forward. Accordingly, since the height of knees or the bending angle of ankles of the passenger can be adjusted by changing the tilt of the seat face even when the height of the passenger's hip point is at the constant level, the proper operation of the pedals and the comfortable sitting position can be provided.

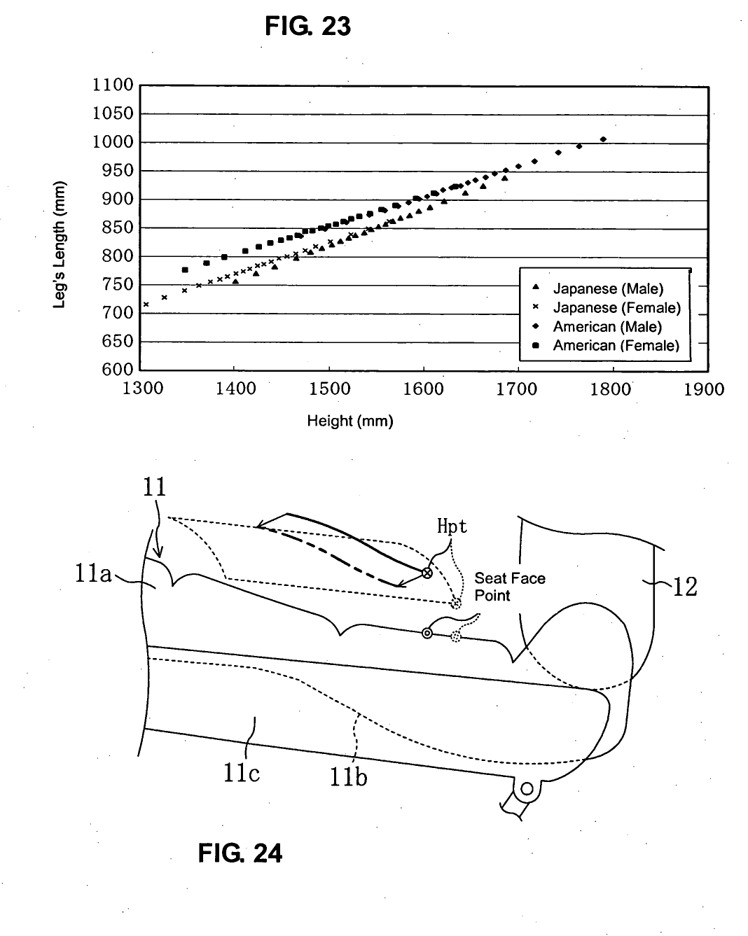

Herein, FIG. 23 shows the relationships between the passenger's height and the passenger's leg length, in which the taller passenger has longer legs and the ratio of the leg length relative to the height changes depending on a human race (Japanese, American etc.). It can be said here that since the taller passenger has longer legs and higher sitting height, the seat needs to be located rearward and its seat face needs to be lowered and for the shorter passenger, the seat needs to be located relatively forward and its sitting seat face needs to be relatively higher, with a movement characteristic of the passenger's hip point illustrated by a solid line in FIG. 24. Herein, however, since Americans generally tend to have longer legs than Japanese as shown in FIG. 23, the seat position that is proper to Japanese would not be proper to Americans because the position of eyes of Americans seated may be too low and the bending angle at knees of Americans seated may be too acute. Thus, a movement characteristic of the seat face of the seat needs to be changed so that the hip point's movement characteristic can be one illustrated by a two-dotted broken line in FIG. 24, so that the seat position can be proper to Americans seated in the seat. In FIG. 24, a double circle mark shows a position (a seat face point) on the seat face on which buttocks of the passenger seated contact, and the above-described hip point shows a position of a waist-bone of a standard-sized passenger who is seated on the seat face point. Herein, the position of the waist-bone is obtained based on body size data of the standard body-sized person.

Thus, it is preferable that the movement characteristic of the hip point of the passenger seated on the seat face of the seat cushion, namely the movement characteristic of the seat face point on the seat face is selectable from a plurality of movement characteristics.

According to another embodiment of the present invention, the position adjusting device comprises a movement characteristic selecting device to select one of a plurality of movement characteristics of the seat face point set at the specified position on the seat face, and a seat-face moving device to move the seat face such that the seat face point moves on the movement characteristic selected by the movement characteristic selecting device.

Accordingly, since the seat face point set at the specified position on the seat face of the seat cushion can be adjusted so as to move on any one of the plural movement characteristics, the passenger's hip point set based on the above-described seat face point also moves on the similar movement characteristic. Thereby, the proper sitting can be provided even to passengers with the same height but different length of their legs. For example, one of the plural movement characteristics is set to be proper to passengers who have relatively great ratio of the leg's length relative to the height (e.g., Americans), the other is set to be proper to passengers who have relatively small ratio of the leg's length relative to the height (e.g., Japanese), and these movement characteristics are properly selected according to the passenger's body size. Thereby, the proper sitting can be provided even to passengers with the same height but different length of their legs.

According to another embodiment of the present invention, the seat-face moving device includes a slide device to adjust a longitudinal position of the seat cushion of the seat, and a lift device to adjust a vertical position of the seat cushion in association with the adjustment of said slide device. Accordingly, since the seat-face moving device is comprised of the slide device and the lift device that are known as the seat position adjusting device, the above-described function can be attained with a simple and low-cost device.

Other features, aspects, and advantages of the present invention will become apparent from the following description which refers to the accompanying drawings

### BRIEF DESCRIPTION OF THE INVENTION

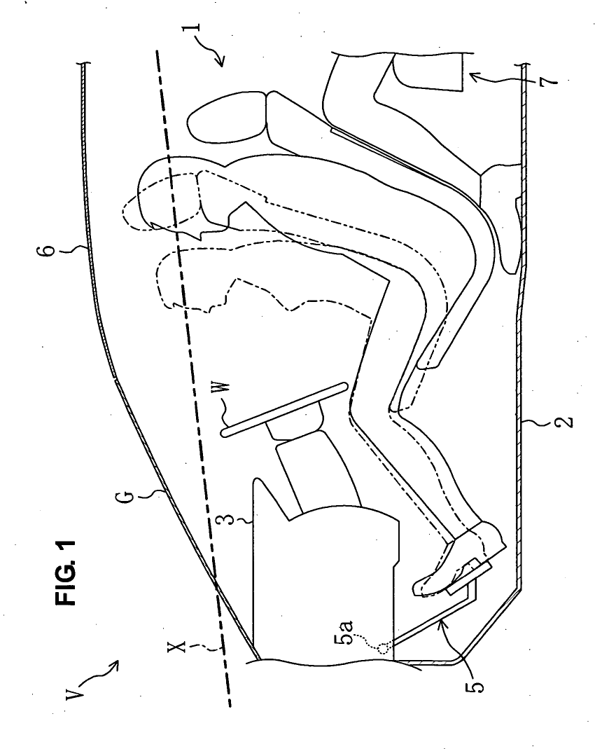

FIG. 1 is a diagram showing a schematic structure of a front portion in a vehicle cabin according to an embodiment of the present invention.

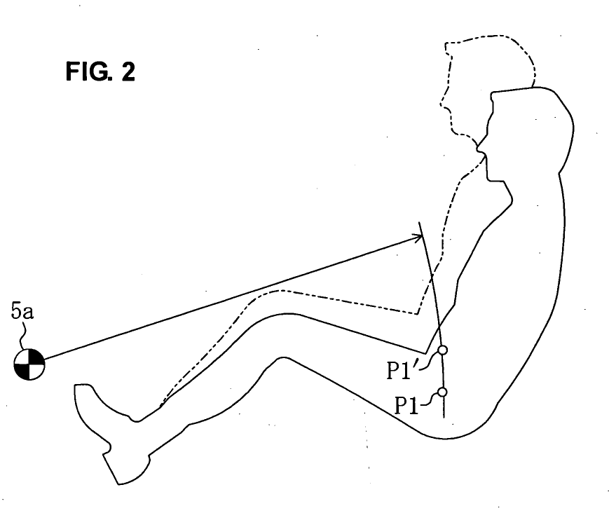

FIG. 2 is an explanatory diagram showing a change of a sitting position of a passenger.

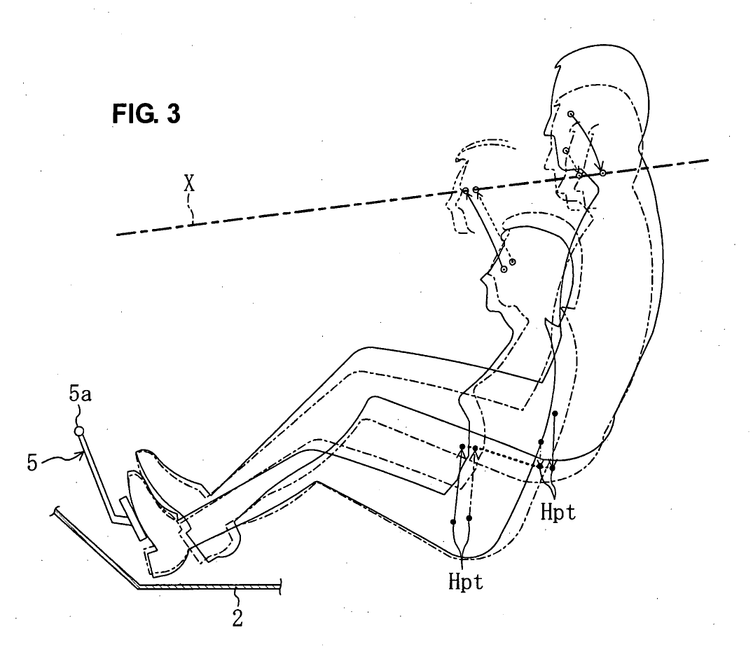

FIG. 3 is an explanatory diagram showing respective hip point's positions of a short passenger and a tall passenger, whose eyes' height are located at a specified level.

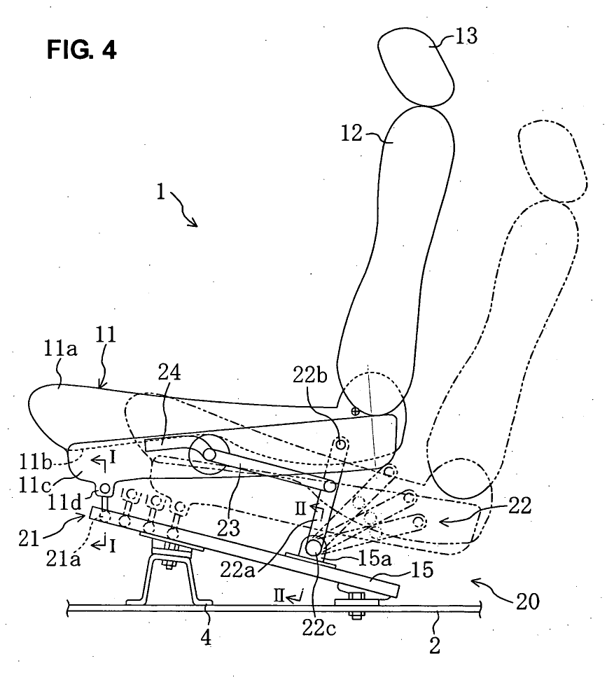

FIG. 4 is a right side view showing a schematic structure of a seat according to an embodiment 1.

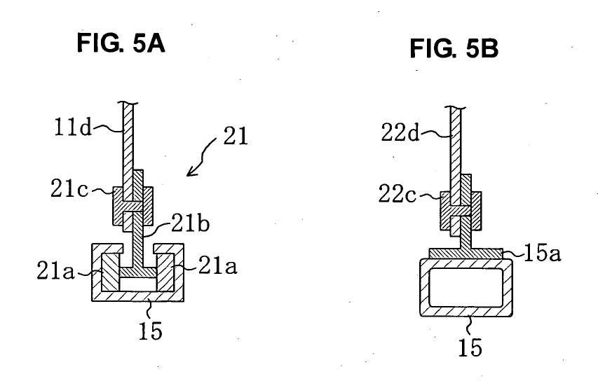

FIG. 5A is a sectional view taken along line I-I of FIG. 4, and FIG. 5B is a sectional view taken along line II-II of FIG. 4.

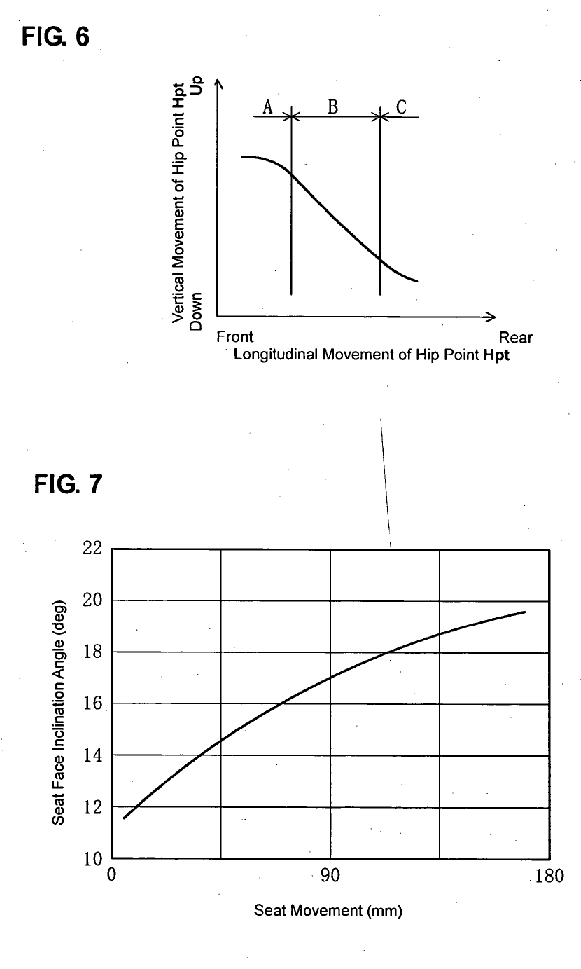

FIG. 6 is a graph showing a movement characteristic of the passenger's hip point relative to a longitudinal position of a seat cushion.

FIG. 7 is a graph showing relationships between the longitudinal position of the seat and a tilt angle of a seat face.

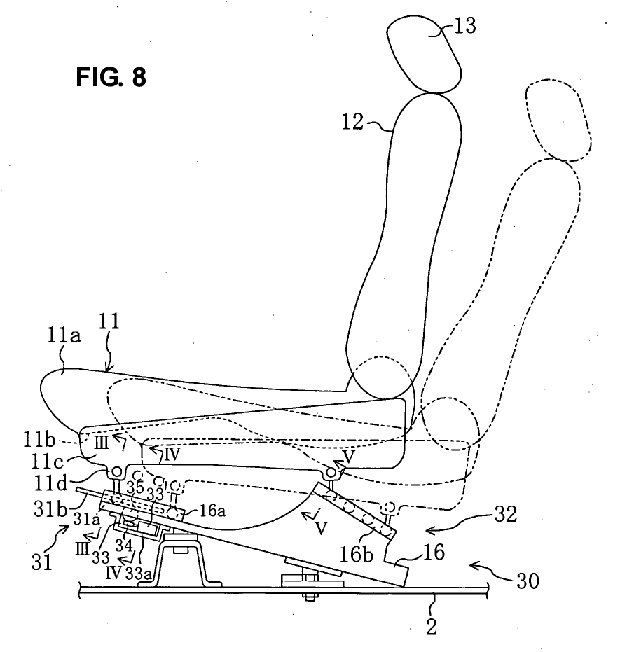

FIG. 8 is a right side view showing a schematic structure of a seat according to an embodiment 2.

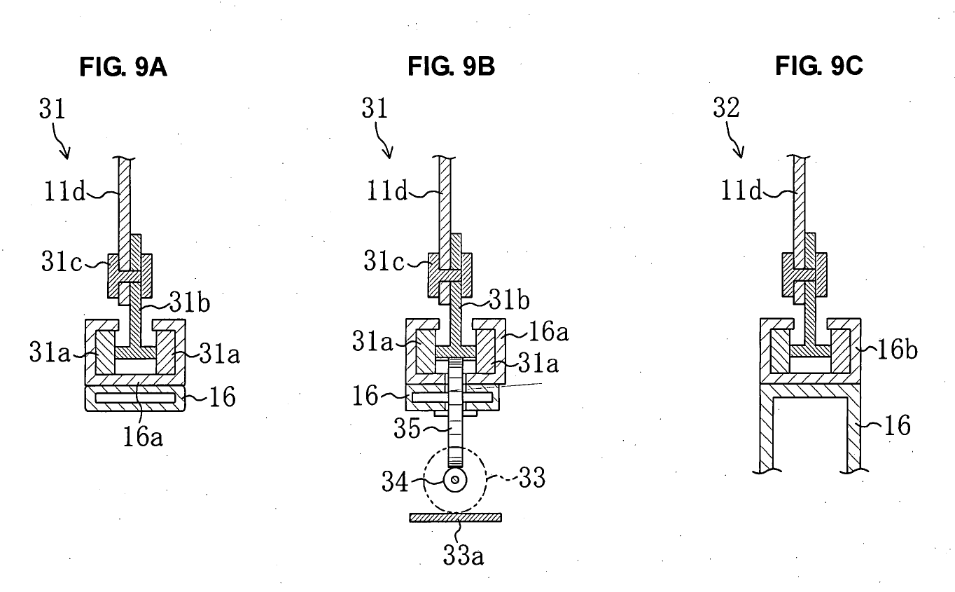

FIG. 9A is a sectional view taken along line III-III of FIG. 8, FIG. 9B is a sectional view taken along line IV-IV of FIG. 8, and FIG. 9C is a sectional view taken along line V-V of FIG. 8.

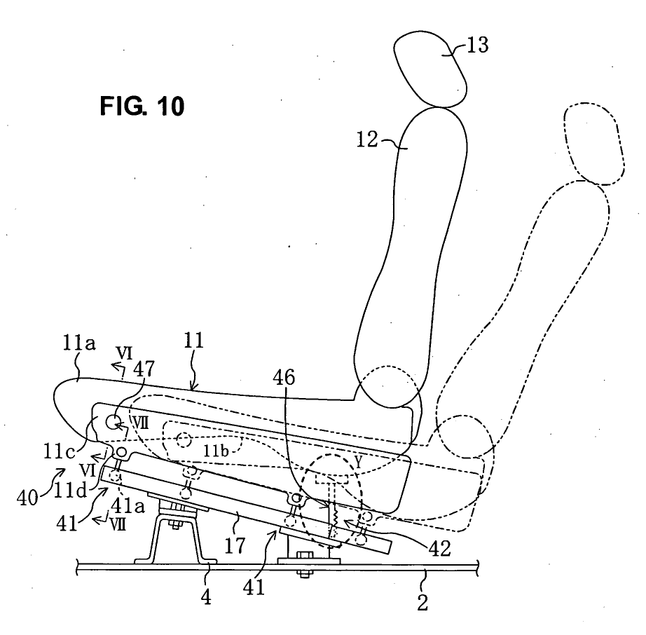

FIG. 10 is a right side view showing a schematic structure of a seat according to an embodiment 3.

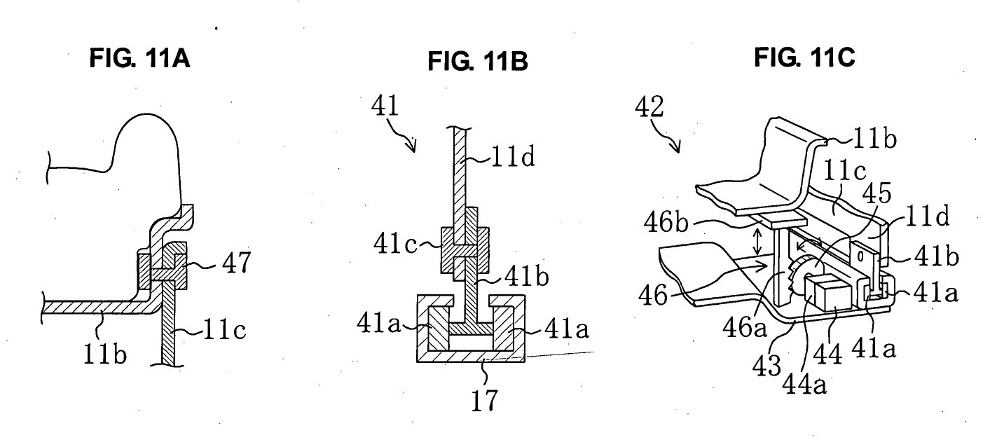

FIG. 11A is a sectional view taken along line V1-V1 of FIG. 10, FIG. 11B is a sectional view taken along line VII-VII of FIG. 10, and FIG. 11C is an enlarged perspective view of Y portion of FIG. 10, when viewed from the front.

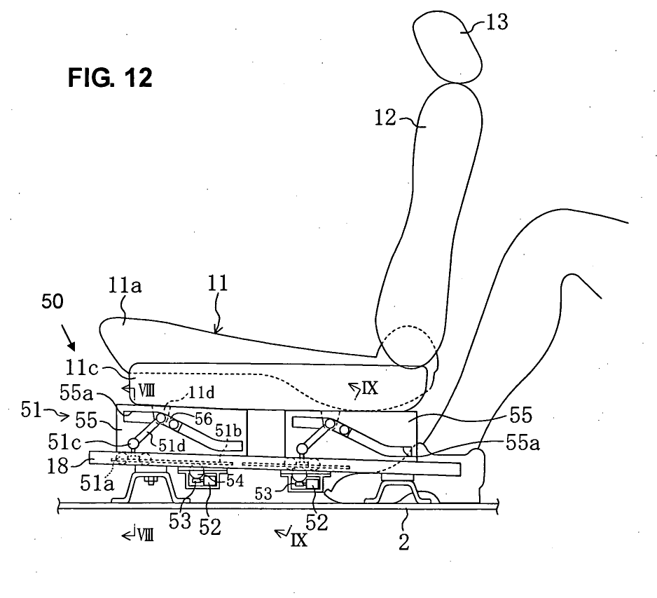

FIG. 12 is a right side view showing a schematic structure of a seat according to an embodiment 4.

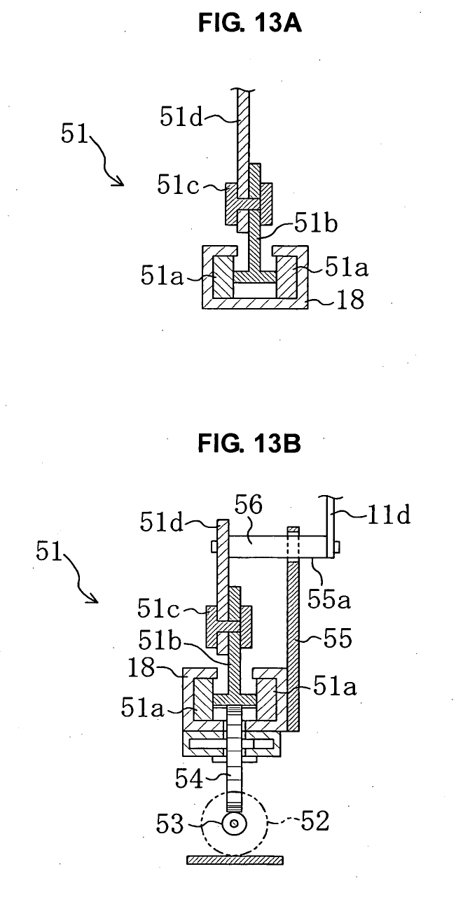

FIG. 13A is a sectional view taken along line VIII-VIII of FIG. 12, and FIG. 13B is a sectional view taken along line IX-IX of FIG. 12.

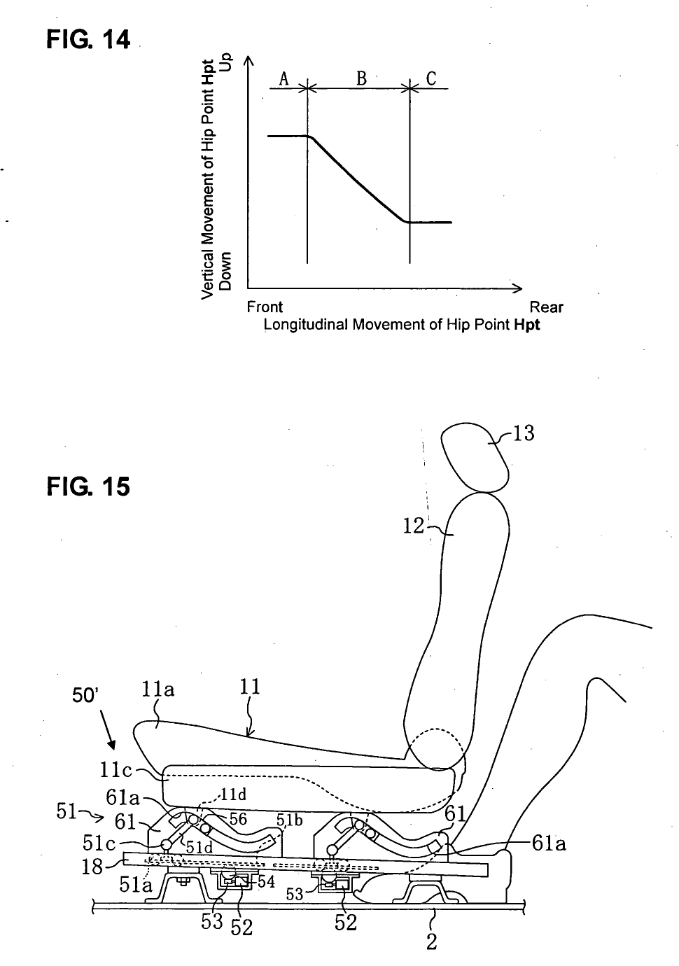

FIG. 14 is a graph showing a movement characteristic of the passenger's hip point relative to the longitudinal position of the seat cushion.

FIG. 15 is a right side view showing a schematic structure of a seat according to an embodiment 5.

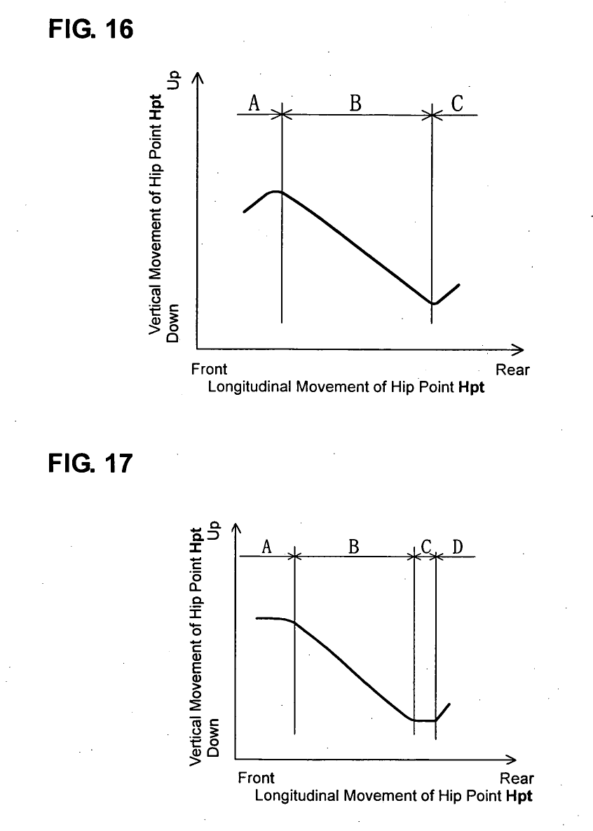

FIG. 16 is a graph showing a movement characteristic of the passenger's hip point relative to the longitudinal position of the seat cushion.

FIG. 17 is a graph showing a modified movement characteristic of the passenger's hip point relative to the longitudinal position of the seat cushion.

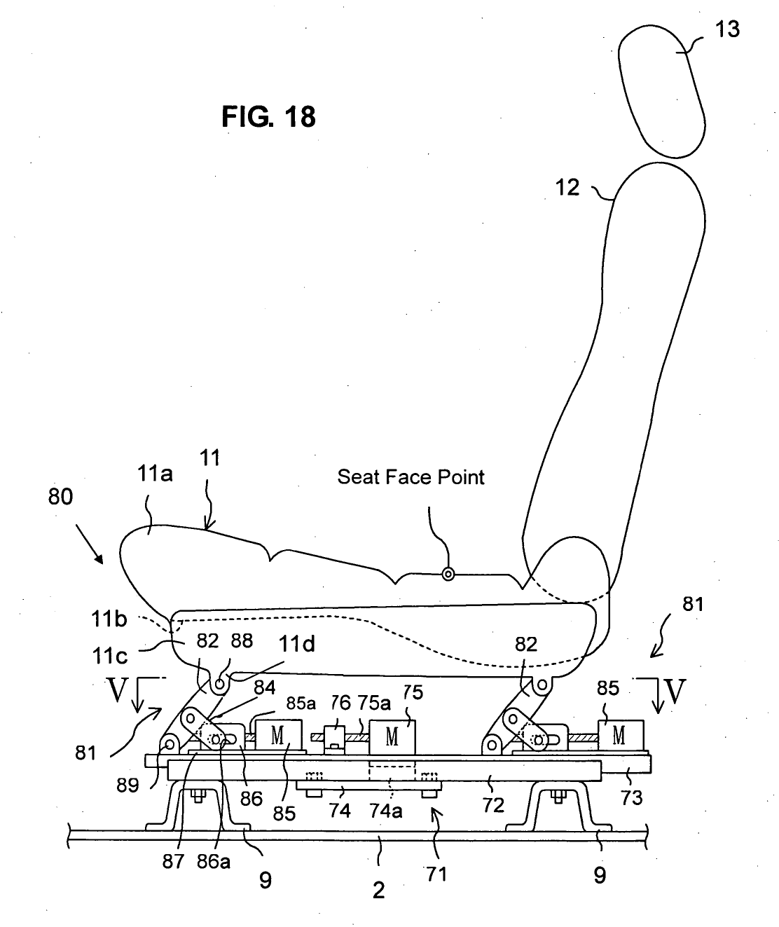

FIG. 18 is a right side view showing a schematic structure of a seat according to an embodiment 6.

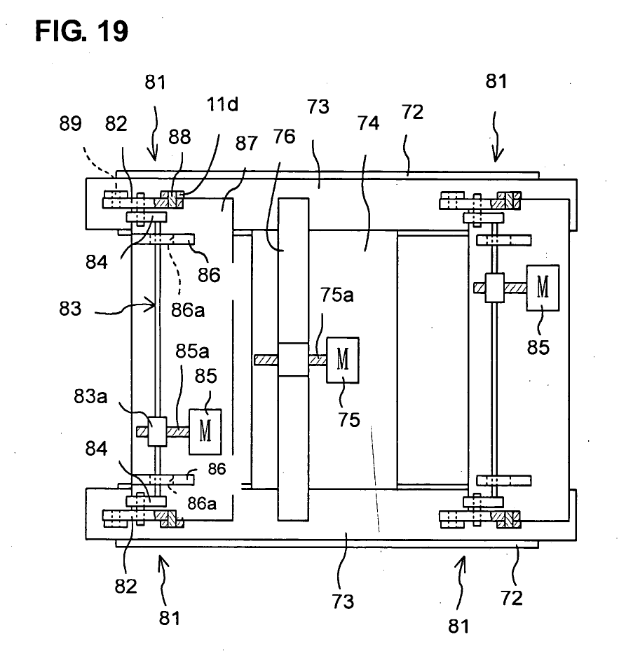

FIG. 19 is a sectional view taken along line V-V of FIG. 18.

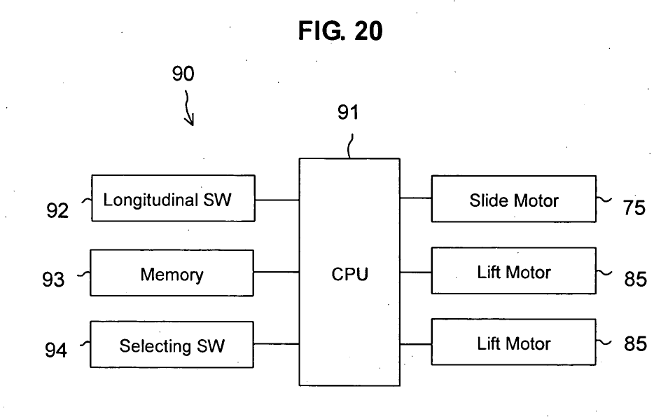

FIG. 20 is a block diagram of a control device to control respective motors.

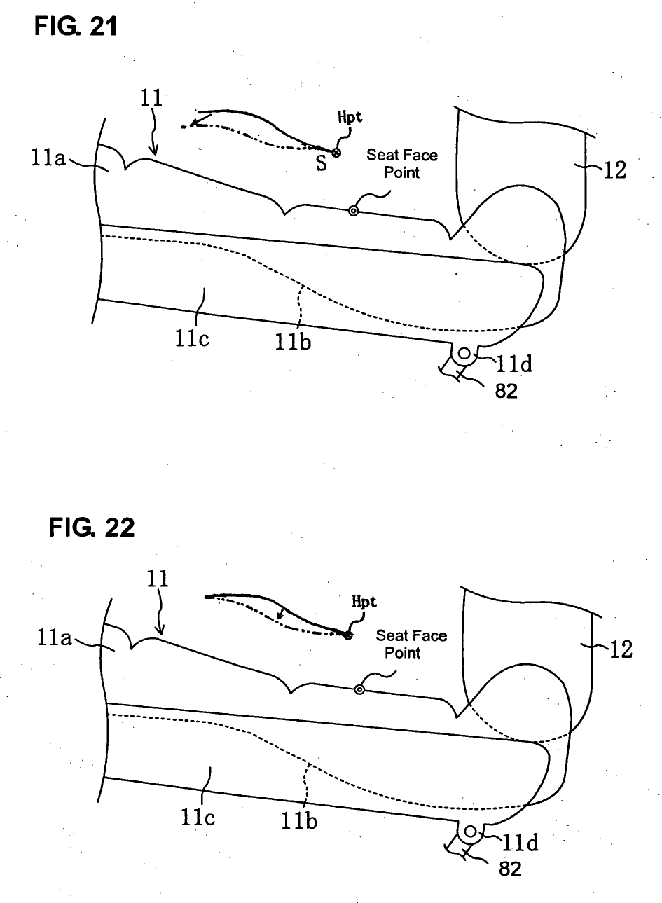

FIG. 21 is a diagram showing movement characteristic of the passenger's hip point.

FIG. 22 is a diagram showing movement characteristic of the passenger's hip point.

FIG. 23 is a graph showing relationships between height and leg's length of Japanese and Americans.

FIG. 24 is diagram showing proper movement characteristics of the hip points of passengers who have the same height but different length of their legs.

FIG. 25 is a right side view showing a schematic structure of a conventional position adjusting mechanism.

FIG. 26 is a graph showing relationships between leg's length and height of the passenger.

### DETAILED DESCRIPTION OF THE INVENTION

Hereinafter, preferred embodiments of the present invention will be described referring to the accompanied drawings. Herein, the embodiments described are just examples and therefore descriptions on these embodiments do not have intension to limit the present invention in its application or usage.

### Embodiment 1

FIG. 1 shows a schematic structure of a front portion in a vehicle cabin of an automotive vehicle V according to an embodiment 1 of the present invention. There are provided a seat 1 for a passenger located at the front portion on a floor panel 2, and an instrument panel 3 disposed below a windshield G at the vehicle front. A steering wheel W is provided so as to project from the instrument panel 3 toward the passenger, and a pedal 5, such as a brake pedal, is disposed at a space below the instrument panel 3. A roof 6 is disposed so as to extend from the windshield G rearward over the seat 1, and there is provided a rear seat 7 behind the seat 1.

The seat 1 is adjustable in its seat face's longitudinal and vertical positions and its seat face's tilt and the like so that the passenger seated who has different body size can have a proper eyes' height X to obtain a clear front view beyond an engine hood, not illustrated, and a proper operations of the pedal 5 with the passenger's foot and a comfortable sitting can be obtained, as shown in FIG. 1.

Namely, the seat 1 is configured so as to change its position in such a manner that the passenger's position can be rotated around a rotational center 5a of the pedal 5 without changing bending angles at the passenger's knees and ankles (form a solid-line position to a broken-line position) regardless of the body size of the passenger, as illustrated in FIG. 2. Thus, the seat position can be adjusted so as to provide the eyes' height that is proper to any passengers with the different body sizes. For example, to a relatively tall passenger, the longitudinal position of the seat 1 may be adjusted to be a rearward position and its vertical position may be adjusted to be a downward position. As shown in FIG. 2, the passenger's hip point is moved from P1 to P1′ as the sitting position of the passenger is changed.

When the passenger's position is rotated, as described above, around the rotational center 5a of the pedal 5 such that the passenger can have the proper eyes' height for the clear front view beyond the engine hood, the amount of vertical movement of hip points (Hpt) of a tall passenger and a short passenger (respectively shown by slid lines) is not so different from that of hip points of a little shorter passenger than the tall passenger and a little taller passenger than the short passenger (respectively shown in dash-dotted lines) as shown in FIG. 3 (see a movement characteristic of the hip points, which is shown by a bold broken line). Namely, it is necessary that the hip point's vertical position of the relatively short passenger may not be located so high for the better operation of the pedal 5, while the hip point's vertical position of the relatively tall passenger may not be located so low for the proper eyes' height. Thus, the seat 1 according to the present invention is configured such that its seat face can be adjusted so as to meet relationships of the hip point's position shown in FIG. 6.

Namely, in the movement characteristic of the passenger's hip point relative to the longitudinal position of the seat cushion shown in FIG. 6, when the short passenger is seated in the seat 1, namely the seat face of the seat 1 is located at a front-side in the movable area of the seat (front section A), the degree of the vertical moving (rising) of the hip point (Hpt) relative to the longitudinal movement is configured to be relatively small compared with its degree when the seat face of the seat 1 is located at a central side in the movable area of the seat (central section B), so the position of the passenger's hip point does not become too high. Meanwhile, when the tall passenger is seated in the seat 1, namely the seat face of the seat 1 is located at a rear side in the movable area of the seat (rear section C), the degree of the vertical moving (lowering) of the hip point (Hpt) relative to the longitudinal movement is configured to be relatively small compared with its degree when the seat face of the seat 1 is located at the central section B as well, so the position of the passenger's hip point does not become too low.

Hereinafter, a specific structure of the seat 1 will be described.

The seat 1 comprises, as illustrated in FIG. 4, a seat cushion 11 to support the weight of the passenger, a seat back 12 extending upward from the seat cushion 11 to support the passenger's back, and a headrest 13 provided at the upper end of the seat back 12. Below the seat cushion 11 is provided a position adjusting mechanism 20 as a position adjusting device operative to move the seat 1 longitudinally and vertically.

The seat cushion 11, in which a cushion material, such as urethane, and springs are disposed, comprises a cushion portion 11a that bends downward when receiving the passenger's weight, an inner pan 11b to support the cushion portion 11a from below, and an outer pan 11c to cover the inner pan 11b from below. These members 11a, 11b and 11c are moved as an integral unit longitudinally and vertically.

The position adjusting mechanism 20, which is disposed between a pair of support members 15, 15 that extend longitudinally with its font being located at a higher position and the outer pan 11c of the seat cushion 11, comprises a slide portion 21 to movably support the front of the seat cushion 11 on the slide members 15 and a link portion 22 to rotatably support the rear of the seat cushion 11 at the slide members 15. A front portion of each support member 15 has a substantially U-shaped open cross section, while a rear portion of each support member 15 has a substantially rectangular closed cross section. At the portion with the substantially U-shaped open cross section is provided the above-described slide portion 21, and to the portion with the substantially rectangular closed cross section is pivotally connected the above-described link portion 22 via pins or the like. The front of the support members 15, 15 are fixed on a cross member 4 disposed on the floor panel 2 in such a manner the font is located at the higher position.

More specifically, as shown in FIG. 5A, the slide portion 21 is configured so as to move (slide) longitudinally in the substantially U-shaped cross section of the support member 15. It comprises two cylindrical rollers 21a, 21a and a connecting member 21b with a substantially reverse-T shape to rotatably support the rollers 21a, 21a. An upper portion of the connecting member 21b is pivotally connected to a bracket portion 11d extending downward from the outer pan 11c via a pin 21c. Thereby, the roller 21a, 21a can rotate and move smoothly in the in the substantially U-shaped cross section of the support member 15 even if the angle of the seat cushion 11 relative to the support members 15 changes.

Meanwhile, the link portion 22 is configured, as shown in FIGS. 4 and 5, such that an upper end of the bar-shaped link member 22a and its lower end are pivotally at the outer pan 11c and a bracket 15a on the support member 15 via a pin 22b and a pin 22c, respectively. Also, the link portion 22a is coupled to an operating lever 24 at its center portion via a middle member 23. Namely, the link portion 22 rotates the link member 22a forward around the pin 22c of the support member 15 with the middle member 23 being pulled forward by rotating the operating lever 24 upward. Then, by rotating the operating lever 24 downward, the middle member 23 is pushed rearward, thereby the link member 22a rotates rearward around the pin 22c. Namely, the longitudinal movable range of the seat face of the seat cushion 11 is determined by the rotatable range of the link portion 22.

Accordingly, when the seat cushion 11 is moved forward by the movement of the link portion 22, the seat face of the seat cushion 11 is inclined forward (when it is moved rearward, the seat face is greatly inclined rearward) as shown in FIG. 7. Thereby, the angles at the knees and ankles of the passenger seated in the seat 1 can be maintained substantially to be constant regardless of the longitudinal position of the seat cushion 11, thereby maintaining the comfortable position of the passenger. Accordingly, the link member 22 changing the tilt of the seat face of the seat cushion 11 corresponds to a tilt mechanism. FIG. 7 shows a tilt angle of the seat face relative to the floor surface, and the greater angle means to be further inclined rearward.

In the above-described structure, when the operating lever 24 is rotated upward, the link member 22a of the link portion 22 rotates forward relative to the support member 15, thereby the seat cushion 11 is moved forward and upward. Herein, the cylindrical members 21a, 21a at the slide portion 21 moves forward in the substantially U-shaped cross section, thereby the front portion of the seat cushion 11 is moved forward. Meanwhile, when the operating lever 24 is rotated downward from the upward position, the link member 22a of the link portion 22 rotates rearward relative to the support member 15, thereby the seat cushion 11 is moved rearward and downward. Herein, conversely the cylindrical members 21a, 21a at the slide portion 21 moves rearward in the substantially U-shaped cross section, thereby the front portion of the seat cushion 11 is moved rearward.

Since the support members 15 supporting the slide portion 21 and the link portion 22 are provided in such a manner that its front is located at the high position as described above, the seat cushion 11 rises with the forward movement, so the hip point of the passenger seated in the seat cushion 11 also rises as the seat cushion is moved forward.

Herein, a bending characteristic of the cushion portion 11a of the seat cushion 11 may be set so that the hip point's position of the passenger has the relationship to the above-described longitudinal movement of the seat cushion 11 shown in FIG. 6 by the position adjusting mechanism 20. This bending characteristic may be determined considering a property that the relatively tall passenger seated in the seat 1 located rearward has relatively thick buttocks (hip) and heavy weight, while the relatively short passenger seated in the seat 1 located forward has relatively thin buttocks (hip) and light weight. Namely, the bending characteristic of the seat cushion 11a may be determined based on a model body size that is set according to the longitudinal position of the seat cushion 11, considering change of the thickness of passenger's buttocks and the passenger's weight.

### Embodiment 2

In another embodiment 2, as shown in FIGS. 8 and 9A, B and C, there is provided a position adjusting mechanism 30 that comprises a front slide portion 31 and a rear slide portion 32. A rear mechanism that is comprised of a slide mechanism and a motor 33 that is provided to move the seat cushion 11 longitudinally are what is different from the previous embodiment 1. Hereinafter, these different portions of the present embodiment 2 will be described.

The outer pan 11c of the seat cushion 11 is, as shown in FIG. 8, coupled to support members 16 fixed on the floor panel 2 at its front portion and its rear portion via slide members 31, 32, respectively. The support members 16 extends longitudinally and their front portions are fixed on the cross member 4 in such a manner that they are located at the high position, like the embodiment 1. Each support member 16 has rails members 16a, 16b with the substantially U-shaped cross sections at its front and rear portions that correspond to the front and rear slide portions 31, 32. The portion having the rear rail member 16b is formed so as to project upward, so that the rear portion of the seat cushion 11, namely the above-described slide portion 32 is located at a specified position.

The rear rail member 16b is disposed with a greater inclination relative to the floor surface compared with the front rail member 16a. Thus, the seat face of the seat cushion 11 tilts forward as the seat cushion 11 is moved forward as shown in FIG. 7, like the embodiment 1. Thereby, the angles at the knees and ankles of the passenger seated in the seat 1 can be maintained substantially to be constant regardless of the longitudinal position of the seat cushion 11, thereby maintaining the comfortable position of the passenger. Accordingly, the rail member 16b and the slide portion 32 that can change the tilt of the seat face of the seat cushion 11 correspond to the tilt mechanism.

The slide portions 31, 32 have slide mechanisms similar to the above-described slide portion 21 of the embodiment 1 as shown in FIGS. 9A, 9B and 9C, and so descriptions of their detailed structure are omitted here. The slide portion 31 comprises the motor 33 operative to move the seat cushion 11 longitudinally, and the drive mechanism of the motor will be described.

The motor 33, which is attached below the support member 16 via an attaching member 33a, transfers a drive torque to a connecting member 31b to rotatably support cylindrical members 31a, 31a of the slide portion 31. Specifically, the connecting member 31b is comprised of a flat plate extending in a longitudinal direction of the support member 16, and its lower face is formed in a shape to engage with a second gear 35, which comprises a so-called rack mechanism. Also, there are formed through holes at upper and lower faces of the support member 16 and a lower face of the rail member 16a, respectively. The second gear 35 is positioned to be located through these holes.

Accordingly, the rotational drive torque of the motor 33 is transferred to the second gear 35 via a first gear 34 directly couple to the motor 33, so the connecting member 31b of the slide portion 31, which engages with the second gear 35, is moved longitudinally. Thereby, the outer pan 11c coupled to the connecting member 31b via a pin 31c is also moved longitudinally and thus the longitudinal position of the seat 1 is adjusted. Herein, the longitudinal movable range of the seat face of the seat cushion 11 of the seat 1 is, of course, determined by the longitudinal moveable range of the slide portion 31.

Since the support member 16 having the slide portions 31, 32 is disposed slant with its higher front end like the above-described embodiment 1, the seat 1 rises as it is moved forward. As a result, the hip point of the passenger seated in the seat 1 also rises as the seat is moved forward.

Also, like the embodiment 1, the bending characteristic of the seat cushion 11 may be set so that the hip point's position of the passenger has the relationship shown in FIG. 6. Thereby, the proper sitting position can be provided to any passengers with different body sizes. Namely, it becomes possible that the hip point's position of the relatively tall passenger is not located too low for the proper eyes' height, while the hip point's position of the relatively short passenger is not located too high for the better operation of the pedal 5. Accordingly, the proper seat position adjusting can be obtained according to the passenger's body size.

Further, the above-described position operation of the seat cushion 11 can be carried out just by the longitudinal movement operation of the seat cushion 11. Namely, since the position adjusting mechanism 30 adjusts the vertical position, longitudinal position and tilt angle of the seat face of the seat cushion 11, the only single operation can provide the proper sitting position adjustment.

### Embodiment 3

In further another embodiment 3, as shown in FIGS. 10 and 11, there is provided a position adjusting mechanism 40 that comprises a front slide portion 41, a rear slide portion 42, and a lift portion 42 that is located behind the rear slide portion 41 to move the seat cushion 11. The rear slide portion 41 and the lift portion 42 are what is different from the previous embodiment 1. Hereinafter, these different portions of the present embodiment 3 will be described.

The lift portion 42 provided at the rear portion of the seat cushion 11 is provided at a plate member 43 interconnecting a pair of support members 18, 18 as shown in FIG. 11C, and comprises a motor 44 provided on the plate member 43, a gear 45 driven by the motor 44, and a lift member 46 having an engagement portion 46a engaging with the gear 45. There is provided a gear box 44a as a reduction gear between the motor 44 and the gear 45, so all weights of the set cushion 11 and the passenger seated would not directly applied to the motor 44.

The lift member 46 comprises a pole-shape member and a contact plane portion 46b that is provided at the top end of the pole-shaped member and contacts a lower face of the inner pan 11b of the seat cushion 11. The pole-shaped member has the above-described engagement portion 46a at its center, and its lower end gets through a through hole formed at the plate member 45. These lift member 46 and the gear 45 driven by motor 44 comprise a rack mechanism.

Thereby, the rotational drive of the motor 44 rotates the gear 44 and the lift member 46, whose engagement portion 46a engages with the gear, is moved vertically.

Herein, the cushion portion 11a and the inner pan 11b of the seat cushion 11 are formed integrally, and the inner pan 11b is coupled to the outer pan 11c via pins 47, 47 at the both sides of vehicle front so as to be rotatable relative to the outer pan 11c, as shown in FIGS. 10 and 11A.

Accordingly, when being moved upward by the rotational drive of the motor 44, the lift member 46 contacts the lower face of the inner pan 11b and lifts up the cushion portion 11a. Meanwhile, when the lift member 46 is lowered from that position, the inner pan 11b and the cushion portion 11a go down.

Herein, the front and rear slide portions 41, 41 have the same structure and are moved longitudinally by a motor (not illustrated) or the like. The slide mechanism and drive mechanism by the motor are the same as those in the previous embodiments 1 and 2, and so their detailed descriptions are omitted here. Basically, however, cylindrical members 41a, 41a of the slide portion 41, 41 move longitudinally in a support member 17 with a substantially U-shaped cross section, and thereby the seat cushion 11 is moved longitudinally via the outer pan 11c coupled to the upper end of a connecting member 41b that connects the cylindrical members 41a, 41a via a pin 41c. The longitudinal movable range of the seat face of the seat cushion 11 is determined by the longitudinal movable range of the slide portions 41, 41.

Since the support member 17 is disposed slant with its higher front end like the above-described embodiments, the seat cushion 11 rises as it is moved forward. Also, the above-described lift member 43 lifts up the rear portion of the seat cushion 11. As a result, the hip point of the passenger is moved forward and upward.

Since when the lift portion 43 lifts up the rear portion of the seat cushion 11 as described above, the seat face of the seat cushion 11 tilts forward as the seat cushion 11 is moved forward like the embodiment 1 as shown in FIG. 7, the bending angles at the knees and ankles of the passenger seated in the seat 1 can be maintained substantially to be constant regardless of the longitudinal position of the seat cushion 11, thereby maintaining the comfortable position of the passenger. This lift portion 43 to change the tilt of the seat face of the seat cushion 11c corresponds to the tilt mechanism.

In addition, like the previous embodiments, the bending characteristic of the cushion portion 11a of the seat cushion 11 may be set so that the hip point's position of the passenger has the relationship shown in FIG. 6. Thereby, the proper sitting position can be provided to any passengers with different body size. Namely, it becomes possible that the hip point's position of the relatively tall passenger is not located too low for the proper eyes' height, while the hip point's position of the relatively short passenger is not located too high for the better operation of the pedal 5.

Further, the above-described position operation of the seat cushion 11 can be carried out just by the longitudinal movement operation of the seat cushion 11. Namely, since the position adjusting mechanism 40 adjusts the vertical position, longitudinal position and tilt angle of the seat face of the seat cushion 11, the only single operation can provide the proper sitting position adjustment.

### Embodiment 4

According to a further another embodiment 4, the seat cushion 11 is moved in such a manner that the hip point of the passenger seated in the seat 1 is positioned at the constant level at the front portion (front section A) and the rear portion (rear section C) regardless of the longitudinal position of the seat cushion 11, namely in a manner of relationships as shown in FIG. 14. A position adjusting mechanism 50 comprising slide and guide portions, as shown in FIGS. 12 and 13 is what is different from the previous embodiment 1. Hereinafter, these different portions of the present embodiment 4 will be described.

Namely, as shown in FIG. 12, there are provided a pair of support members 18 extending longitudinally in parallel to the floor panel 2, which have their substantially U-shaped cross section. The seat cushion 11 has at the front and rear portions thereof slide portions that slide longitudinally in substantially U-shaped cross sections of the slide portions 51, 51. The slide portions 51, 51 have the similar structure to those in the embodiments 1 through 3, so their detailed descriptions are omitted here. Basically, however, two cylindrical members 51a, 51a that rotate and move in the support members 18 are rotatably connected via a connecting member 51b having a substantially reverse-T shape, and a coupling member 51d is pivotally supported at an upper portion of the connecting member 51b via a pin 51c.

Below the support member 18 is provided motors 52 to move the slide portions 51, 51 longitudinally, and the torque is transferred to the slide portions 51, 51 via respective first gears 53 coupled to the motors 52 and respective second gears 54 engaging with the first gears 53. The drive mechanism by the motors 52 is the same as that in the previous embodiment 2, so its detailed descriptions are omitted here. Basically, however, the connecting member 51b is comprised of a plate member, and its lower face has an engagement shape that engages with the second gear 54, which comprises the so-called rack mechanism to convert the rotation of the motor 52 to a straight-line movement of the each slide portion 51.

Meanwhile, as shown in FIG. 13B, a guide plate 55 that has a substantially crank-shaped guide hole 55a for providing the passenger's hip point position shown in FIG. 14 is provided inside the support member 18 (at a side of the seat cushion 11) so as to be located along the support member 18 and substantially perpendicularly to the floor panel 2. And, a guide member 56 is disposed so as to move in the guide hole 55a of the guide plate 55. The guide member 56 is coupled to the coupling member 51d via a pin at its one end, and connected to the bracket portion 11d of the outer pan 11c of the seat cushion 11 at its other end.

Accordingly, when the motor 52 rotates, the rotational torque is transferred to the connecting member 51b of the slide portion 51 via the first and second gears 53, 54, so the connecting member 51b is moved longitudinally. Herein, two cylindrical members 51a, 51a connected to the connecting member 51b properly rotate, so the slide portion 51 moves smoothly longitudinally.

As the slide portion 51 moves longitudinally, the guide member 56 moves along the guide hole 55a of the guide plate 55 via the coupling member 51d coupled to the upper of the connecting member 51b. Thus, the seat cushion 11 connected to the guide member 56 is moved along the shape of the guide hole 55a. Herein, although the guide hole 55a is formed in the substantially crank shape as shown in FIG. 12, a connecting portion between the guide member 56 and a connecting portion between the coupling member 51d and the connecting member 51b are respectively rotated longitudinally as the guide member 56 moves. Thereby, the guide member 56 can move smoothly in the guide hoe 55a. Herein, the longitudinal movable range of the seat face of the seat cushion 11 is determined by the longitudinal movable range of the guide member 56 in the guide hole 55a.

As described above, when the seat cushion 11 is moved longitudinally, the seat cushion 11 moves along the shape of the guide hole 55a. As a result, the hip point's position of the passenger seated in the seat 1 can be changed with the relationship shown in FIG. 14. Accordingly, the proper operation of the pedal 5 can be provided to the relatively short passenger, while the proper eyes' height can be provided to the relatively tall passenger, so that the proper sitting position can be provided to any passengers with different body size.

Also, the seat face' position of the seat cushion 11 is adjusted such that the height of the hip point is maintained at the constant level when the seat cushion 11 is positioned at the front portion (front section A). Thereby, the gap between the passenger and the vehicle roof is not made too narrow, and thus a sense of oppression may not be provided to the passenger.

Further, the seat face' position of the seat cushion 11 is adjusted such that the height of the hip point is maintained at the constant level when the seat cushion 11 is positioned at the rear portion (front section C). Thereby, the foot space of the passenger seated in the rear seat is not made too narrow, and thus a sense of oppression for the foot space may not be provided to the passenger as well.

In addition, since the seat face of the seat cushion 11 is maintained at the constant level at the specified range as described above, the vertical movable area of the seat cushion 11 can be made small by the position adjusting mechanism 50. Thereby, a space for vertical movement of the seat 1 in the cabin is made small, and thus the space utility around the seat 1 can also be improved.

Furthermore, the above-described position of the seat cushion 11 can be easily obtained by the single operation of the longitudinal movement for the seat cushion 11.

Although the seat face of the seat cushion 11 is maintained at the constant level at the front portion and the rear portion, this constant-level adjustment may be provided at either portion, namely, only at the front portion or at the rear portion.

### Embodiment 5

According to a further embodiment 5, the seat cushion 11 is moved in such a manner that the hip point of the passenger seated in the seat 1 goes down when the seat cushion 11 is positioned at the front portion, while it goes up when the seat cushion 11 is positioned at the rear portion, namely in a manner of relationships as shown in FIG. 16. A position adjusting mechanism 50′ comprising guide plates with a different shape of guide holes from the guide plate of the previous embodiment 4, as shown in FIG. 15, which is what is only different from the embodiment 4. Hereinafter, this different portion of the present embodiment 5 will be described.

Namely, as shown in FIG. 15, there are provided a pair of support members 18 extending longitudinally in parallel to the floor panel 2. Inside the support members 18 (at the side of the seat cushion 11) are provided guide plates 61 that are located along the support members 18 and perpendicularly to the floor panel 2. Each guide plate 61 has a guide hole 61a having a substantially S shape, which provides the relationship of the passenger's hip point shown in FIG. 16.

Accordingly, when the slide portions 51, 51 are moved longitudinally by the motors 52, 52, that movement is transferred to the guide members 56 provided in the guide holes 61a via the coupling members 51d, 51d and thereby the guide members 56 move in the guide holes 61a. Herein, since the seat cushion 11 is connected to the guide members 56 at the bracket portions 11d of the outer pan 11c, the seat cushion 11 goes up and down along the shape of the holes 61a as the guide members 56 move in the guide holes 61a.

As described above, when the seat cushion 11 is moved longitudinally, the seat cushion 11 moves along the shape of the guide holes 61a. As a result, the hip point's position of the passenger seated in the seat I can be changed with the relationship shown in FIG. 16. Accordingly, the proper operation of the pedal 5 can be provided to the relatively short passenger, while the proper eyes' height can be provided to the relatively tall passenger, so that the proper sitting position can be provided to any passengers with different body sizes.

Also, the seat cushion 11 is adjusted such that the height of the hip point goes down when the seat cushion 11 is positioned at the front portion (front section A). Thereby, the gap between the passenger and the vehicle roof is not made too narrow, and thus the sense of oppression may not be provided to the passenger.

Further, the seat cushion 11 is adjusted such that the height of the hip point goes up when the seat cushion 11 is positioned at the rear portion (front section C). Thereby, it is prevented that a rear end of the seat cushion 11 or the seat back 12 would contact a leg of the passenger seated in the rear seat and the foot space of the rear passenger is not made too narrow, and thus a sense of oppression for the foot space may not be provided to the passenger.

In addition, since the seat face of the seat cushion 11 is maintained at the constant level at the specified range as described above, the vertical movable area of the seat cushion 11 can be made small by the position adjusting mechanism 50′. Thereby, a space for vertical movement of the seat 1 in the cabin is made small, and thus the space utility around the seat 1 can also be improved.

Furthermore, the above-described position of the seat cushion 11 can be easily obtained by the single operation of the longitudinal movement for the seat cushion 11.

Although the seat face of the seat cushion 11 is maintained at the constant level at the front portion and the rear portion, this constant-level adjustment may be provided at either portion, namely, only at the front portion or at the rear portion.

Herein, the present invention should not be limited to the above-described embodiments. Although the seat face's height of the set cushion 11 is maintained at the constant level at the rear section C in the embodiment 4, the seat face may be changed so as to rise as the seat cushion 11 is moved rearward at a rearmost area (rear most section D) as shown in FIG. 17. Thereby, the proper sitting position can be provided to the relatively tall passenger. Also, since the seat cushion 11 is moved such that its rear end or the seat back 12 changes their positions along the shape of the leg of the rear passenger, from its instep from its knee, a sense of oppression may not be provided to the passenger.

Further, although the movement characteristic of the hip point of the passenger has the similar shapes at the front section A and the rear section C, different shapes may be adopted for the respective sections A and C. For example, the shape of the movement characteristic of the embodiment 1 may be applied to the section A, while that of the embodiment 4 may be applied to the section C. Herein, these movement characteristics can be obtained by adopting the guide holes having such different characteristic hole shapes.

Also, the embodiments 4 and 5 may comprise the tilt mechanism or a resilient member 70 like the embodiments 1 through 3. Accordingly, the passenger's hip point can change surely along the specified movement characteristic even if the cushion portion 11a is changed by the weight of the passenger and the like.

### Embodiment 6

According to a further embodiment 6, the seat cushion 11 is moved in such a manner its movement characteristic is selectable from a plurality of movement characteristics.

Namely, in the present embodiment 6, there is provided a position adjusting mechanism 80 comprising a slide portion 71 (slide device) that slides the seat cushion 11 by a motor and a lift portions 81, 81 . . . (slide device) that moves the seat cushion 11 longitudinally and vertically by another motor.

The slide portion 71 comprises, as shown in FIGS. 18 and 19, a pair of lower rails 72, 72 that are provided on cross members 9, 9, a pair of upper rails 73, 73 that are placed to slide longitudinally on the lower rails 72, 72, and a motor 75 that is provided on a support plate 74 placed on the lower rails 72, 72 to move the upper rails 73, 73 relative to the lower rails 72, 72. The motor 75 has an output shaft 75a with a screw portion formed thereon, which engages with a screw hole of a connecting member 76 fixed to the upper rails 73, 73. Accordingly, as the motor 75 fixed to the lower rails 72, 72 rotates, the connecting member 76 with the screw hole is moved relative to the output shaft 75a with the screw portion. In FIG. 18, there is provided a spacer 74a between the motor 75 and the support plate 74 so that the output shaft 75a of the motor 75 and the screw hole of the connecting member 76 are aligned concentrically.

The lift portions 81, 81 . . . are provided on the upper rails 73, 73 at respective portions below the four corners of the seat cushion 11, and comprises a link mechanism to move the seat cushion 11 vertically and longitudinally relative to the upper rails 73, 73. Specifically, each lift portion 81 includes a link member 82 that is pivotally connected to the bracket 11d projecting downward from the outer pan 11c of the seat cushion 11 and the upper rail 73 at its both ends via pins 88, 89, a middle member 84 that is pivotally connected to the center of the link member 82 and a connecting shaft 83, which will be described below, at its both ends, and a motor 85 that drives the connecting shaft 83 longitudinally.

The connecting shaft 83 is comprised of a long member extending laterally to interconnect the middle members 84, 84 of the right and left lift portions 81, 81, and is disposed so as to get through long guide holes 86a, 86a formed at guide plates 86, 86 that are provided inside the middle members 84, 84. Also, the connecting shaft 83 has a projecting portion 83a with a screw hole, which engages with a screw portion formed on the output shaft 85a of the motor 85. The motor 85 and the guide plates 86, 86 are fixed to a plate member 87 placed on the upper rails 73.

Accordingly, when the motor 85 rotates, the screw portion of the output shaft 85a of the motor 85 also rotates and thereby the projecting portion 83a with the screw hole is moved along with the connecting shaft 83. Herein, since the connecting shaft 83 is moved longitudinally along the guide holes 86a, 86a of the guide plates 86, 86, even if the downward force acts on the connecting shaft 86 with the weight of the passenger in the seat cushion 11, the connecting shaft 83 may not be moved greatly in the vertical direction by the downward force.

Then, as the connecting shaft 83 is moved longitudinally, the middle member 84 connected to the connecting shaft 83 is also moved longitudinally, so the longitudinal force is transferred to the link member 82 to which one end of the middle member 84 is connected. Thus, the middle member 84 is connected to the center of the link member 82, and the both ends of the link member 82 are pivotally connected to the outer pan 11c of the seat cushion 11 and the upper rail 73 of the slide portion 71, respectively, Thereby, the link member 82 rotates longitudinally around the connecting portion with the upper rail 73. As a result, the seat cushion 11 is moved forward and upward, or the rearward and downward.

Herein, the motor 75 of the slide portion 71 and the motors 85, 85 of the lift portion 81 are controlled by a control device 90 shown in FIG. 20. Namely, these motors 75, 85, 85 are coupled to CPU 91 of the control device 90, and also to the CPU 91 are coupled a longitudinal switch 92 operative to move the seat cushion 11 longitudinally, a memory 93 to memorize a plurality of movement characteristics of the seat cushion 11, a movement-characteristic selecting switch 94 (movement-characteristic selecting device) operative to have the passenger select one of a plurality of movement characteristics memorized in the memory 93. When a specified movement characteristic is selected by the passenger with the movement-characteristic selecting switch 94, the control signals for the respective motors 75, 85, 85 are read from the memory 93 and then outputted to these motors according to the output signals of the longitudinal switch 92.

According to the above-described structure, the movement characteristics of the passenger's hip point (Hpt) are selectable, for example, from the ones shown in FIGS. 21 and 22. Namely, as shown in FIG. 21, there are provided a specified movement characteristic (first movement characteristic, shown by a solid line) and another movement characteristic (second movement characteristic, shown by a two-dotted broken line) that has the same characteristic of a rear part behind a specified S position and a forward-advanced characteristic of a front part before the S position. According to the characteristics, since the hip point is not lowered too much when it is located rearward, the movable range of the lift portions 81 can be narrowed and thereby the structure of the lift portions 81 can be made compact and the space for movement can be made small. Herein, the above-described specified position S may be properly determined so at to provide the proper sitting position to any passengers with different ratio of the leg's length relative to the height. For example, it may be located at the foremost position, which could provide the common movement characteristic of the passenger's hip point regardless of the different ratio of that. In FIGS. 18, 21 and 22, the double circles show the positions of the seat face point, and they show respectively the positions of the seat face point where the seat cushion 11 (the hip point) is located at the rearmost location in FIGS. 21 and 22.

Also, there may be provided another example of movement characteristics as shown in FIG. 22. Namely, there are provided a specified characteristic that would be suitable to the passenger with the small ratio of the leg's length relative to the height (first movement characteristic, shown by a solid line) and another movement characteristic that would be suitable to the passenger with the great ratio of the leg's length relative to the height (second movement characteristic, shown by a two-dotted broken line), which have the same characteristic of the front end part and the rear end part. Accordingly, the vertical movable range of the hip point can be further narrowed compared to that shown in FIG. 21 and thereby the structure of the lift portions 81 can be made compact and the space for movement can be made small. Herein, although the vertical movement is suppressed at the both end parts of the movement characteristics in the above, it may be suppressed at either one of the end parts.

Herein, the control data of the respective motors 75, 85, 85 to allow the passenger's hip point to move along the movement characteristics shown in FIGS. 21 and 22 is stored in the movement characteristic memory 93. Accordingly, by the passenger selecting any preferable movement characteristic with the movement-characteristic selecting switch 94, the position of the hip point can be changed to flow the selected characteristic shown in FIGS. 21 and 22 by operating the longitudinal switch 92 to simply move the seat cushion 11 longitudinally. Herein, the above-described slide portion 71, lift portion 81 and control device 90 correspond to the seat-face moving device. The CPU 91, which reads in from the memory 93 the control data of the motors 75, 85, 85 for the selected movement characteristic of the hip point, corresponds to the movement-characteristic selecting device.

According to the present embodiments the seat cushion 11 can be moved in such a manner the preferable movement characteristic is selectable from a plurality of movement characteristics, by controlling the movement of the slide portion 71 and the lift portion 81 with the motors 75, 85, 85.

Herein, the present invention should not be limited to the above-described embodiment. The selectable movement characteristics of the hip point (Hpt) may be set as shown in FIG. 24. Namely, taking into account that the short passenger (generally, a female passenger) has the ratio of the leg's length relative to the height that is different from that of the tall passenger (generally, a male passenger) despite the same human race, the movement characteristics may be set such that the vertical movement is relatively small compared to the longitudinal movement when the hip point is located at the front side or the rear side.

What is claimed is:

1. A seat position adjusting device of an automotive vehicle, comprising:
a seat operative to be movable in a vehicle longitudinal direction; and
a position adjusting device operative to adjust a position of a seat face of a seat cushion of said seat,
wherein said position adjusting device adjusts the seat face's position in such a manner that a hip point of a passenger seated in the seat lowers as the seat cushion is moved rearward at least in a specified area where the seat is movable, and a degree of the hip point lowering is configured such that said lowering degree of the hip point at a central section in said specified area is greater than that of the hip point lowering at a rear section and a front section that are located behind and before said central section respectively.

2. A seat position adjusting device of an automotive vehicle of claim 1, wherein said position adjusting device adjusts the seat face's position in such a manner that a vertical position of said hip point of the passenger is kept substantially at a constant level at said rear section in the specified area.

3. A seat position adjusting device of an automotive vehicle of claim 1, wherein the vehicle comprises another seat located behind said seat, there is further provided a rearmost area that is located behind said rear section in the specified area, said position adjusting device adjusts the seat face's position in such a manner that said hip point of the passenger seated in the seat rises as the seat is moved rearward at said rearmost area.

4. A seat position adjusting device of an automotive vehicle of claim 1, wherein said position adjusting device adjusts the seat face's position in such a manner that a vertical position of said hip point of the passenger is kept substantially at a constant level at said front section in the specified area.

5. A seat position adjusting device of an automotive vehicle of claim 1,, wherein said position adjusting device adjusts the seat face's position in such a manner that said hip point of the passenger seated in the seat lowers as the seat is moved forward at said front section in the specified area.

6. A seat position adjusting device of an automotive vehicle of claim 1, wherein said position adjusting device comprises a tilt mechanism to adjust the seat face's position in such a manner that the seat face's position tilts forward as the seat is moved forward.

7. A seat position adjusting device of an automotive vehicle of claims 1, wherein said position adjusting device comprises a movement-characteristic selecting device to select one of a plurality of movement characteristics of a seat face point set at a specified position on the seat face, and a seat-face moving device to move the seat face such that the seat face point moves on the movement characteristic selected by said movement characteristic selecting device.

8. A seat position adjusting device of an automotive vehicle of claim 7, wherein said seat-face moving device includes a slide device to adjust a longitudinal position of the seat cushion of the seat, and a lift device to adjust a vertical position of the seat cushion in association with the adjustment of said slide device.

9. A seat position adjusting device of an automotive vehicle, comprising:
a seat operative to be movable in a vehicle longitudinal direction; and
a position adjusting device operative to adjust a position of a seat face of a seat cushion of said seat, the position adjusting device comprising a front slide portion and a rear slide portion, which are provided at a front side and a rear side of the seat cushion to support the seat cushion, and a motor to move the seat cushion longitudinally,
wherein said position adjusting device adjusts the seat face's position in such a manner that a hip point of a passenger seated in the seat lowers as the seat cushion is moved rearward at least in a specified area where the seat is movable, and a degree of the hip point lowering is configured such that said lowering degree of the hip point at a central section in said specified area is greater than that of the hip point lowering at a rear section and a front section that are located behind and before said central section respectively.
